(19) United States
(12) Patent Application Publication
(10) Pub. No.: US 2013/0099169 A1
(43) Pub. Date: Apr. 25, 2013

(54) METHODS AND COMPOSITIONS FOR PASSIVATING HEAT EXCHANGER SYSTEMS

(71) Applicants: Regis J. Pellet, Croton on Hudson, NY (US); Sandra G. Claeys, Lovendegem (BE); Serge S. Lievens, Merelbeke (BE); Douglas P. Hunsicker, Peoria, IL (US)

(72) Inventors: Regis J. Pellet, Croton on Hudson, NY (US); Sandra G. Claeys, Lovendegem (BE); Serge S. Lievens, Merelbeke (BE); Douglas P. Hunsicker, Peoria, IL (US)

(73) Assignee: Chevron U.S.A. Inc., San Ramon, CA (US)

(21) Appl. No.: 13/307,081

(22) Filed: Nov. 30, 2011

Related U.S. Application Data
(63) Continuation-in-part of application No. 12/185,662, filed on Aug. 4, 2008, now abandoned.
(60) Provisional application No. 60/953,623, filed on Aug. 2, 2007.

(51) Int. Cl. C09K 15/02

(52) U.S. Cl. CPC C09K 15/02
USPC 252/382

(57) ABSTRACT

A process for extending the life of coolant fluids by passivating surfaces of components and parts in heat exchanger systems that employ coolants for heat transfer. In the method, heat exchanger parts with metal surfaces which chemically and detrimentally interact with additives in coolant fluids in the heat exchanger system are treated by contacting the metal surfaces with a phosphate-containing solution for the phosphate-containing solution to passivate the metal surface for subsequent contact with the coolant fluids.

### CROSS-REFERENCES TO RELATED APPLICATIONS

This is a continuation-in-part application and claims priority from U.S. patent application Ser. No. 12/185,662, filed Aug. 4, 2008, which claims priority from U.S. Provisional Application No. 60/953,626, filed Aug. 2, 2007.

### FIELD OF THE INVENTION

The invention relates generally to compositions and methods for passivating surfaces of components and parts in heat exchanger systems that employ coolants for heat transfer, thereby extending the life of the coolant fluids.

### BACKGROUND

Methods for producing heat exchange systems have changed over the years with increased used for lighter materials such as aluminium and alloys thereof. Construction methods have also changed with the use of brazing, e.g., controlled atmosphere brazing or CAB with the brazing in a controlled N₂ gas environment using a potassium fluoroaluminate flux. Flux is applied to the surfaces of the heat exchange parts to be joined, the assembled unit is heated in a N₂ environment, and joining occurs.

Coolants (heat transfer fluids) are used to take away heat from heat exchange systems such as engines. It is known to add corrosion inhibitors to coolants to reduce corrosion of metallic systems. For example, U.S. Pat. No. 4,664,833 discloses a coolant system with a corrosion inhibiting amount of a nitrate salt. U.S. Pat. No. 4,587,028 discloses non-silicate antifreeze formulations containing alkali metal salts of benzoic acid, dicarboxylic acids and nitrate. U.S. Pat. No. 4,647,392 discloses a corrosion inhibitor comprising the combination of an aliphatic monoacid or salt, a hydrocarbyl dibasic acid or salt and a hydrocarbonyl triazole.

Brazed materials have been in use in cooling systems for decades. Previously (see ASTM STP 705 (1979 April)) “Corrosion Testing of Furnace and Vacuum Brazed—Aluminum Radiators”), it was thought that materials used to braze aluminium were chemically inert towards cooling system fluids. Recent investigations show that the presence of flux in heat exchanger systems such as radiators generally leads to an increase in the corrosion rate of coolant fluids used in the systems. See “Investigation of Interaction Between Coolant Formulations and Flux Loading/Compositions in Controlled Atmosphere Brazed (CAB) Aluminium Surfaces in Heat Exchanger Applications” by Jeffcoate et al., Journal of ASTM International, Vol. 4, No. 1, paper ID JAI100421. Other tests have shown a fast depletion of some coolant inhibitors in heat exchangers, specifically nitrogen and silicate-based inhibitors, along with an increase in the pH of the coolant fluids used in the systems which severely impact the performance of the coolant.

It is known in the art to treat metal surfaces by dipping in acidic aqueous phosphate solutions containing controlled amounts of zinc ions and phosphate ions for a sufficient period of time to form a uniformly dense phosphating coating with adhesion and anticorrosion properties, and specifically useful as an under coat for electrode position coating. However, phosphate salts although known to inhibit aluminum corrosion, are unacceptable to a number of original equipment manufactures. See for example, Ford Engineering Material Specifications “Coolant, Organic Additive Technology, Concentrate,” Specification No. WSS-M97BB44-C.

There is a need to extend the life of coolant fluids in heat exchanger systems employing aluminium and alloy parts, particularly systems having brazed parts. In one embodiment, the invention relates to a novel method to extend the life of coolant fluids in heat exchanger systems, utilizing a solution containing phosphate ions to wash/passivate the aluminium parts and components of the heat exchanger systems prior to contact with the coolant fluids.

### SUMMARY OF THE INVENTION

In one aspect, there is provided a method for treating parts in a heat exchanger system, which parts have metal surfaces which chemically and detrimentally interact with additives in coolant fluids in the heat exchanger system, by contacting the metal surfaces with a phosphate-containing solution for the phosphate-containing solution to passivate the metal surface for subsequent contact with the coolant fluids.

In another aspect, the invention relates to the use of a phosphate-containing solution having a pH of 4.0-12.0 and containing 0.005 to 30 g/l of phosphate ions to treat parts in a heat exchanger system, which parts have metal surface that chemically and detrimentally interact with additives in coolant fluids in the heat exchanger system. In the treatment process, the phosphate ions in the phosphate-containing solution reduce the chemical activity of the metal surface for subsequent contact with the coolant fluid.

### DETAILED DESCRIPTION

Definitions for the following terms are provided herein to promote a further understanding of the invention.

As used herein, the term “heat exchange system” refers to applications wherein cooling systems are used, including but not limited to fuel cell assemblies, appliances and engine applications. Non-limiting examples include heater cores and radiators for engines as commonly used in automobiles, trucks, motorcycles, aircrafts, trains, tractors, generators, compressors, for various stationary engine and equipment applications, marine engine applications and the like.

As used herein, the term “heat exchange component” refers to parts, bodies, or components of heat exchange systems, including but not limited to radiators, water pump, thermostats, engine head, cylinder liners, separator plates in fuel cells, heater cores, and the like.

As used herein, the term “treat,” “treating” or “treated” may be used interchangeably with “passivate,” “passivating,” or “passivated,” referring to one embodiment of the invention, wherein the heat exchanger part is washed (brought into contact) with the phosphate-containing solution to reduce the chemical reactivity of the washed surface, which is to be subsequently in contact with coolant fluids in the heat exchanger system.

The term “heat transfer fluid” refers to a fluid which flows through a heat exchange system in order to prevent its overheating, transferring the heat produced within the system to other systems or devices that can utilize or dissipate the heat.

As used herein, the term “antifreeze” composition (or fluid or concentrate) may be used interchangeably with “coolant,” “heat transfer fluid” or “de-icing fluid” (composition or concentrate).

As used herein, “glycol-based” includes glycols, glycerins, as well as glycol ethers.

In one embodiment of the invention, a method to treat heat exchanger parts, e.g., surfaces such as heater cores, radiators and brazed parts, etc., is provided. The parts are treated with a passivating solution to reduce the chemical reactivity of their surfaces.

Passivating Solution:

The composition for passivating surfaces in heat exchange systems contains as its essential ingredient phosphate ions, in a pH range of 4.0-12.0. In a second embodiment, the composition is a neutral to slight alkaline solution containing phosphate ions having a pH of 6.5-11.

The phosphate ions are present in the solution in a sufficient amount to reduce the chemical activity of the surfaces in contact with the coolant fluid. In one embodiment, the sufficient amount of phosphate ions is from 0.005 to 30 g/l of solution. In a second embodiment, the phosphate ions are present in an amount from 0.01 to 25 g/l of solution In a third embodiment, from 1 to 15 g/l. In a fourth embodiment, from 0.5 to 12 g/l. In a fifth embodiment, from 0.3 to 10 g/l.

The phosphate ions can be introduced to the solution in the form of any soluble phosphate compound including alkali metal phosphates, ammonium phosphates, polyphosphates, pyrophosphates, phosphoric acid, and the like. In one embodiment, the passivating solution comprises dipotassium hydrogen phosphate (K₂HP0₄) in solution. In a second embodiment, the solution comprises mono potassium phosphate (KH₂P0₄) in aqueous solution. In a third embodiment, the passivating solution is a solution of diammonium phosphate.

In one embodiment, the passivating solution is aqueous based, with the aqueous medium being selected from the group consisting of water, neutral aqueous solutions, acidic aqueous solutions and basic aqueous solutions. In a second embodiment, the passivating solution comprises di potassium hydrogen phosphate in a water base with a sufficient amount of at least an alkali metal hydroxide, e.g., NaOH or KOH, added for its pH to be between 7 and 10. In a third embodiment, the passivating solution has as its base a glycol based or non-glycol based coolant, as the heat transfer fluid to be used in the system is subsequently a glycol or non-glycol based antifreeze.

In one embodiment, the phosphate-containing passivating solution has as its base a glycol-based solution containing glycol or glycol ether in an amount of 2 to 97 wt. % of total weight of a final passivating solution. In a second embodiment, the amount of glycol or glycol ether ranges from 2 to 50 wt. %. Non-limiting examples include alkylene glycols, such as ethylene glycol, diethylene glycol, propylene glycol, dipropylene glycol; triethylene glycol, tetraethylene glycol, pentaethylene glycol, hexaethylene glycol, dipropylene glycol, tripropylene glycol, tetrapropylene glycol, pentapropylene glycol, hexapropylene glycol and mixtures thereof and glycol monoethers such as the methyl, ethyl, propyl, and butyl ethers of ethylene glycol, and mixtures thereof.

In yet another embodiment, the phosphate-containing passivating solution has as its base a non-glycol aqueous medium containing at least an alkali metal salt of anions selected from acetates, formates, proprionates, adipiates, and succinates, in an amount of 2 to 97 wt. % of total weight of a final passivating solution. Suitable examples of non-glycol based aqueous medium include but are not limited to glycerine, ethanol, potassium formate, potassium propionate, potassium acetate, dipotassium adipinate, and mixtures thereof.

In one embodiment, one or more components known in the art as “phosphating accelerators” can be optionally added to the passivating solution, allowing the surfaces to be treated more uniformly with the phosphate ions. Examples include m-nitrobenzene sulfonate ions at 0.05 to 2 g/L, hydroxylamine in free or bound form at 0.1 to 10 m-nitrobenzoate ions at 0.05 to 2 g/l, p-nitrophenol at 0.05 to 2 g/l, hydrogen peroxide in free or bound form at 1 to 70 mg/l, organic N-oxides at 0.05 to 10 g/l, nitroguanidine at 0.1 to 3 g/l. nitrite ions at 1 to 500 mg/l, and chlorate ions 0.5 to 5 g/l.

In yet another embodiment, traditional corrosion inhibitors known in the art can be optionally added to the phosphate containing solution in an amount ranging from 0.005 to 10 wt. %. Non-limiting examples include triazoles, nitrates, nitrites, silicates, borates, molybdates, organic aromatic and aliphatic acid salts and mixtures thereof. In one embodiment, the phosphate containing passivating solution further comprises at least a corrosion inhibitor selected from the group of alkali metal borates, alkali metal silicates, alkali metal benzoates, alkali metal nitrates, alkali metal nitrites, alkali metal molybdates, hydrocarbyl thiazoles, and mixtures thereof.

The combination of soluble phosphate compounds and optional additives can be blended into the aqueous medium matrix individually or in various sub-combinations to formulate the passivating solution. The passivating solution may be in the form of a single package or in the form of two packages, with one containing the passivating solution (with the phosphate ions), and one containing a coolant which can be a diluted form of the coolant fluid to be subsequently used in the heat exchanger system.

Method for Treating/Passivating Surfaces in Heat Exchanger Systems:

In one embodiment, the treatment/passivating process is carried out at a temperature ranging from 10 to 140° C., with the passivating solution maintained at a temperature ranging from 20 to 90° C. In one embodiment, the treating process is carried out at room temperature.

The passivating solution can be applied to the surface to be treated using methods known in the art, including spraying, immersions, circulation of fluid in cooling system or by a no-rinse method such as using rollers. Whether the passivating solution is applied by spray, no-rinse method, or immersion, in one embodiment, the treating time is between 5 seconds and 12 hours. In a second embodiment, the time is from 30 seconds and 6 hours. In a third embodiment, the treatment time is between 5 minutes and 2 hours. In a fourth embodiment, the treatment time ranges from 15-60 minutes.

In one embodiment, after treatment with the passivating solution, the heat exchanger system may be drained and the treated parts are optionally rinsed with a rinse solvent, e.g. deionized water. In another embodiment, the system may be rinsed with a diluted concentration of the coolant fluid to be added to the heat exchanger system, thus minimizing the amount of and/or any residual effect of any passivating solution that may be retained in the system. Lastly, after the treatment (and optional rinsing step), coolant fluids for the normal operation of the heat exchanger system can be finally added to the system.

In one embodiment, the treatment with the passivating solution may clean the surfaces of the parts/components in the heat exchange systems. The solution may also remove oil, sludge, corrosion products and other undesirable contaminants and/or deposits on the surface of the parts. The composition may disperse and/or dissolve these species into the solution, which solution is subsequently removed/drained away along with the undesirable species in the optional rinsing step.

Applications:

The passivating solution is useful for treating heat exchanger systems having metal parts comprising components that chemically and detrimentally interact with additives in coolant fluids. As used herein, “chemically and detrimentally interact with additives” means that at least an additive in the coolant fluid is reduced in efficacy and/or useable lifetime, as measured by the amount of active ingredients in the additive, with a reduction of at least 25% reduction in at least an additive such as a corrosion inhibitor after 2 weeks in use. The detrimental chemical interaction can also be shown in a change in the pH of the coolant over time, e.g., a change in the pH of at least ±1 after 2 wks.

In one embodiment, the method is for treating heat exchanger parts formed by processes including casting, rolling, forming, brazing, and combinations of the above. In another embodiment, the method is for treating heat exchanger parts comprising zinc, magnesium, aluminium, alloys of these materials. In yet another embodiment, the method is for treating heat exchanger parts comprising aluminium and/or alloys thereof.

In one embodiment, the method is for treating heat exchanger parts brazed with flux materials that chemically and detrimentally interact with additives in coolant fluids. In another embodiment, the method is for treating parts brazed with a fluorine-containing flux. Non-limiting examples of fluorine-containing fluxing material include potassium fluoroborate, potassium fluoroaluminate, cesium fluoroaluminate, potassium fluorozincate, cesium fluorozincate, and mixtures thereof.

In one embodiment, the treatment using the passivating solution substantially inactivates the chemical reactivity of the metal surfaces in heat exchanger systems towards coolant fluids. In one embodiment of an Organic Acid Technology (OAT) coolant employing a traditional inhibitor such as nitrite, the treatment stabilizes the nitrite depletion when the coolant fluid is added to a heat exchanger system employing treated part, with a reduction in the nitrite level of less than 25% after 2 weeks in use. In a second embodiment, the nitrite reduction level is less than 10%. In a third embodiment, the stability effect of the passivating treatment is shown in the pH level of the coolant, with the coolant pH remains essentially stable, i.e., showing a variation of less than 10% after 2 wks. in use.

### EXAMPLES

The following Examples are given as non-limitative illustration of aspects of the present invention.

In the examples, two different coolant formulations are employed, an OAT coolant and a traditional mineral based coolant, both are from Chevron Corporation. The coolants have compositions with components as listed in Table 1.

TABLE 1

| | | Traditional mineral |
|---|---|---|
| INHIBITOR | OAT Coolant | based coolant |
| Monoacid | X | X |
| Dibasic acid | X | — |
| Aromatic acid | — | X |
| SiO₃²⁻ | — | X |
| NO₃⁻ | — | X |
| B₄O₇²⁻ | — | X |
| PO₄³⁻ | — | — |
| Triazole | X | X |
| MoO₄²⁻ | X | — |
| NO₂⁻ | X | X |

In the examples, coupons (cubes) of ½″ to 1″ in size of brazed aluminium radiator parts were treated by immersion in washing fluids from 15 minutes to overnight (10 hrs.). The parts were brazed with potassium fluoro aluminates as flux materials—which were previously considered an inert material under normal conditions. After washing, the coupons were immersed in the OAT coolant for a period of 2 weeks, with the coolant bath temperature being maintained at about 195° F. For all examples, the OAT coolant has a starting pH of 8.5 and a nitrite level of 580 ppm. pH level, nitrite and fluoride contents in the OAT coolant are measured after the 2 wk. test.

Washing fluid formula E is an aqueous solution employing 1-2 wt. % di potassium hydrogen phosphate (K₂HP0₄). The corrosion inhibitor components making up the washing fluid formulae C-G are shown in Table 2 below, with the phosphate ions in washing fluid formulae E-G provided by di potassium hydrogen phosphate (K₂HP0₄) in the aqueous washing solutions:

TABLE 2

| Washing fluid | | | | F (OAT | G (Traditional |
|---|---|---|---|---|---|
| inhibitors | C | D | E | Coolant) | coolant) |
| Monoacid | X | X | | X | |
| Dibasic acid | X | X | | X | |
| Aromatic acid | | | | | X |
| SiO₃²⁻ | | X | | | X |
| NO₃⁻ | | | | | X |
| B₄O₇²⁻ | | | | | |
| PO₄³⁻ | | | X | X | X |
| Triazole | X | X | | X | X |
| MoO₄²⁻ | | | | | X |
| NO₂⁻ | | | | | X |

In Example 1, the coupon was not treated/washed at all. In Example 2, the coupon was washed with water. In Examples 3-7, the coupons were treated with the washing fluids having compositions shown in Table 2, with the washing fluid compositions E-G having 0.4-2 wt. % of K₂HP0₄ in water, the OAT coolant, or a traditional mineral coolant.

It was found that the passivating treatment was as effective with a short treatment time (e.g., 15 minutes) as with a longer treatment period (overnight). The results of the examples in Table 3 show that once the surface treated with E and F are brought in contact with standard coolant fluids, neither abnormal depletion nor pH shift are observed. Additionally, there is no drastic release of fluoride that is indicative of the reactivity of the potassium fluoro aluminates with the coolant fluid typically used in the heat exchanger system.

TABLE 3

| | | Initial | pH after | Initial | Nitrite after | Fluoride |
|---|---|---|---|---|---|---|
| Example | Washing Procedure | pH | immerging | nitrite | immerging | content (ppm) |
| 1 | A* (none) | 8.5 | 10.3 | 580 | 0 | 174 |
| 2 | B* (water) | 8.5 | 10.1 | 580 | 0 | 138 |
| 3 | C* (OAT coolant) | 8.5 | 9.6 | 580 | 103 | 80 |
| 4 | D* (traditional coolant) | 8.5 | 10.7 | 580 | 0 | 180 |
| 5 | E (phosphate) | 8.5 | 8.0 | 580 | 535 | 75 |
| 6 | F (phosphate with OAT) | 8.5 | 8.3 | 580 | 572 | 55 |
| 7 | G (phosphate w/traditional) | — | — | — | — | — |

For the purposes of this specification and appended claims, unless otherwise indicated, all numbers expressing quantities, percentages or proportions, and other numerical values, are to be understood as being modified in all instances by the term “about.” Accordingly, unless indicated to the contrary, the numerical parameters set forth are approximations that may vary depending upon the desired properties sought to be obtained by the present invention. It is noted that as used herein, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A process for extending the life of coolant fluids employed in heat exchanger systems which employs treating parts in a heat exchanger system which have, at least in part, a brazed metal surface which chemically and detrimentally interacts with additives in coolant fluids in the heat exchanger system, the process comprising-contacting the metal surface with a phosphate-containing solution which contains 0.005 to 30 g/l of phosphate ions and has a pH of 4.0-12.0, wherein the phosphate-containing solution passivates the metal surface for subsequent contact with the coolant fluids.

2. The process of claim 1, wherein the heat exchange system comprises components containing aluminium and/or alloys thereof.

3. The process of claim 1, where the metal surface is brazed with a fluorine-containing flux.

4. The process of claim 3, wherein the fluorine-containing fluxing material is selected from the group of potassium fluoroborate, potassium fluoroaluminate, cesium fluoroaluminate, potassium fluorozincate, cesium fluorozincate, and mixtures thereof.

5. The process of claim 1, for treating heat exchanger systems selected from the group of radiators, water pump, thermostats, engine head, cylinder liners, separator plates in fuel cells, and heater cores.

6. The process of claim 1, for treating heat exchanger systems having parts formed, in addition to brazing, by at least one of casting, forming, rolling, and combinations thereof.

7. The process of claim 1, wherein the composition has a pH of 6.5-11.

8. The process of claim 1, wherein the phosphate ions in the phosphate-containing solution are derived from at least one of alkali metal phosphates, ammonium phosphates, polyphosphates, pyrophosphates, phosphoric acid, and mixtures thereof.

9. The process of claim 1, wherein the phosphate-containing solution comprises 1-2 wt. % K₂HP0₄ in solution.

10. A phosphate-containing solution having a pH of 4.0-12.0 and containing 0.005 to 30 g/l of phosphate ions for treating parts in a heat exchanger system which have, at least in part, a metal surface which chemically and detrimentally interact with additives in coolant fluids in the heat exchanger system, wherein phosphate ions in the phosphate-containing solution reduce chemical activity of the metal surface for subsequent contact with the coolant fluid.

11. The solution of claim 10, wherein the phosphate ions in the phosphate-containing solution are derived from at least one of alkali metal phosphates, ammonium phosphates, polyphosphates, pyrophosphates, phosphoric acid, and mixtures thereof.
